(19) United States
(12) Patent Application Publication
(10) Pub. No.: US 2005/0017173 A1
(43) Pub. Date: Jan. 27, 2005

(54) Individually addressable nanoelectrode array

(76) Inventor: Nalin Kumar, Fort Worth, TX (US)

Correspondence Address: Nalin Kumar, 6808 Meadows West Dr S, Fort Worth, TX, 76132, US

(21) Appl. No.: 10/891,224

(22) Filed: Jul. 14, 2004

Related U.S. Application Data
(60) Provisional application No. 60/487,890, filed on Jul. 15, 2003.

(51) Int. Cl. G01N 23/00

(52) U.S. Cl. 250/306

(57) ABSTRACT

This invention describes a novel method for nanoscale detection, imaging, manipulation and characterization of living cells and biological molecules comprising the steps of: providing an array of one or more nanoelectrodes fabricated on a chip, where the nanoelectrodes extend from one side of the chip to the other; placing living cells and biological molecules on the nanoelectrodes on one side of the chip; applying a focused electron beam in a predetermined manner on one or more nanoelectrodes on the other side of the chip; determining the electrical voltage on each nanoelectrode by measuring the emitted electron current from each nanoelectrode.

### CROSS-REFERENCE TO RELATED APPLICATIONS

This application claims the benefit under 35 U.S.C. 119(e) from U.S. Provisional Application No. 60/487,890, filed Jul. 15, 2003.

### STATEMENT REGARDING FEDERALLY SPONSORED RESEARCH OR DEVELOPMENT

No Government License Rights.

### BACKGROUND OF THE INVENTION—FIELD OF INVENTION

This invention lies generally in the field of methods and apparatus for detecting, imaging, manipulating and characterizing living biological cells and single molecules and, is particularly concerned with the method of individually addressing a large array of nanoscopic electrodes fabricated on a chip to detect, image, manipulate and characterize DNA, biological cells, proteins and protein mixtures placed on the chip.

### BACKGROUND OF THE INVENTION—PRIOR ART

Until about a few decades ago, the biological cells were thought as membrane bags full of freely diffusing and colliding macromolecules. However, that view has changed and there is a great emphasis to understand the sub-cellular and molecular functions inside a cell. There is a need to measure and understand the signaling pathways inside a cell. These signals can be biochemical or electrical in nature. Proper understanding of these signals and ultrastructure of live cells will lead us to novel therapies for cancers, diabetes, and neurodegenerative diseases, such as Parkinson's and Alzheimers.

These signals control the operation and function of the cell, however, currently, there is no technique to measure them at the nanometer resolution scale. Since this is an important application, almost all other imaging techniques have been tried, but suffer from poor resolution.

The currently popular ‘live cell imaging’ techniques are limited to optical confocal microscopy, near field scanning optical microscopy (NSOM) and fluorescence, and have poor resolution limited by the fundamental limits determined by the light wavelength. The best resolution obtained in the optical techniques is on the order of 100 nm.

Over the last 50 years, electron microscopy (EM) has played a crucial role in our current knowledge about the structure of matter including biological cells and tissues. In the study of biological samples, the EM was considered a low resolution tool useful for determination of morphology and pathology of cells and tissues until about a decade ago. The development of cryo-electron microscopy (ET) is a major step toward visualization of cells with a few nm resolution. This technique allows three dimensional imaging and is an ideal tool for determining the structures of biological samples. Further improvements in the electron microscopy techniques such as the transmission electron aberration-free microscope (TEAM) will enable sub-nanometer imaging the sample structure. However, in spite of this excellent resolution, the ET requires that the samples be frozen (to avoid the vaporization of water from the samples inside the microscope), there making the requirement that the biological samples are no longer living. This makes it impossible to measure sub-cellular signals inside a living cell with the current and projected electron microscope techniques.

Scanning probe microscopy (SPM), more commonly referred to as Atomic Force Microscopy (AFM) is another powerful technique, commonly used for imaging of atoms and molecules. In AFM, a sharp conducting tip is scanned over the sample attached to a substrate. The level of information in AFM images depends on the size and shape of the tips used for imaging. Recently, the resolution of AFM technique has been improved with the use of carbon nanotubes (CNTs) as the probe tip. AFM has been recently utilized for many purposes in the field of biology and biotechnology as listed below:

1. Molecular Imaging: In the contact mode, AFM tips have been used to obtain topographical images of biological molecules such as proteins, nucleic acids, and assemblies of these macromolecules (Cai et al, 2001), Umemura et al have used a CNT tip in an AFM to successfully resolve 10-nm pitch of RecA-DNA complexes (Umemura et al, 2001).

2. Functional Imaging In this application, AFM tips are modified with specific functional groups to generate signal contrast resulting from certain chemical properties of the sample being examined.

3. Molecular Manipulation and Chemical Synthesis: Guthold et al have used the AFM tip as a nano-manipulator to manipulate biological molecules such as fibrin fibers and tobacco mosaic virus (Guthold et. al, 1999). In addition they have successfully used the carbon nanotubes as the AFM tips for imaging as well as molecular manipulation. Similarly, Muller et al. have used AFM tips for chemical synthesis of nanostructures by manipulating matter (Muller et al, 1995).

There is no doubt that AFM equipped with nanotube tips is a very important technology for nanoscale imaging and have contributed significantly to of our understanding in the structure of single molecules. However, AFM technology has several limitations as listed below:

1. Only One Tip: AFM typically does not have more than one tip, thus multiple points on a molecule cannot be monitored at the same time. It is possible to fabricate two or more tips side by side, but the issue of getting independent electrical signals from each tip is beyond the capability of state-of-the-art micro-fabrication technology. The major challenge to the use of CNT tips for nanoscale living cell probing has been the inability to make an array with individual addressability. Currently employed fabrication techniques lack the resolution to attach wires to nanoelectrodes at the nanoscale. The state-of-the-art fabrication technology is limited to lines on the order of 100-200 nm, and the routing is extremely difficult when the number of nanoelectrodes goes beyond 100 or so. It is conceivable that the future development of techniques described in this patent will one day enable AFM instruments to have multiple tips with excellent spatial, temporal and electrical resolution.

2. Limited Electrical Properties: Recently Cai et al. have used a gold coated AFM tip to directly measure electrical properties of an oriented DNA molecule (Cai et al, 2001).

However, the limitation of one tip cannot allow the simultaneous probing of multiple spots; or more interestingly, measurement of effects of applying one stimulus (electrical or otherwise) to one part of a molecule on other parts of the molecule in real time.

3. Difficult to Perform Studies of Time Dependent Phenomena: AFM is a spatial imaging technique and it is very difficult to perform studies of time dependent phenomena in real time. It is possible to scan back to the same location time after time but is not ideal with the AFM to do such studies.

Furthermore, the AFM tips are very fragile and must be handled with a lot of care, resulting in significant down time and slow scanning speeds. The slow speed of the AFM is a serious drawback when the instrument is used for manipulation of molecules or synthesis. Furthermore, the scanning of the AFM tip can cause deformation and damage to the sample due to a fairly high pressure within the contact area between the tip and the sample.

Several technologies have recently been disclosed for the detection, imaging, manipulation and characterization of biological cells and molecules.

Peeters (U.S. Pat. Nos. 6,123,819 and 6,325,904 B1) describes nanoelectrode arrays built on a chip that can be used for detection, characterization and quantification of single molecules in solution.

Ying et al (U.S. Pat. Nos. 6,231,744 B1 and 6,359,288 B1) describe nanowire arrays having a relatively constant diameter and techniques and apparatus for fabrication thereof.

Cubicciotti (U.S. Pat. No. 6,287,765 B1) teaches various methods for detecting and identifying single molecules.

Lieber et al (U.S. Pat. No. 6,743,408 B2) describe growth of nanotubes and their use in nanotweezers.

Colbert et al (U.S. Pat. No. 6,756,025 B2) describe a method for growing single wall carbon nanotubes utilizing seed molecules.

Jin (U.S. Pat. No. 6,465,132 B1) describes an article comprising small diameter nanowires and method for making the same.

Nakayama et al (U.S. Pat. No. 6,759,653 B2) describe a probe for scanning microscope produced by focused ion beam machining.

Brown et al (U.S. Pat. No. 6,340,822 B1) describe an article comprising vertically nano-interconnected circuit devices and method for making the same.

The above described technologies are generally used for the detection of one or more molecules. However, none of these technologies are capable of providing simultaneous imaging and manipulation of living cells and molecules with nanoscale spatial resolution and high temporal resolution.

### BACKGROUND OF THE INVENTION—OBJECTS AND ADVANTAGES

It is, therefore, an object of the present invention to provide a method and apparatus for detecting, imaging, manipulating and characterizing living biological cells and molecules placed on a chip with nanoscale spatial resolution.

It is yet another object of the present invention to provide a method and apparatus to image living cells and molecules with a high temporal resolution.

It is yet another object of the present invention to provide a method and apparatus to image the living cells with nanoscale spatial resolution while the cells are placed in liquid medium.

It is another object of the present invention to provide a method and apparatus to image living cells and molecules with a plurality of nanoelectrodes simultaneously.

It is yet another object of the present invention to provide a method and apparatus to image large number of living cells and molecules simultaneously.

It is yet another object of the present invention to provide a method and apparatus to image and manipulate living cells and molecules simultaneously.

It is yet another object of the present invention to provide a method and apparatus to manipulate a large number of living cells and molecules simultaneously at high speed.

It is yet another object of the present invention to provide a method and apparatus to image the interior of living cells with nanoscale spatial resolution.

It is yet another object of the present invention to provide a method and apparatus to image the living cells with nanoscale spatial resolution while the cells are placed in liquid medium.

### SUMMARY OF THE INVENTION

In one aspect this invention provides a novel method for simultaneous nanoscale detection, imaging, manipulation and characterization of living cells and biological molecules comprising the steps of: providing an array of one or more nanoelectrodes fabricated on a chip, where the nanoelectrodes extend from one side of the chip to the other; placing living cells and biological molecules on the nanoelectrodes on one side of the chip; applying a focused electron beam in a predetermined manner on one or more nanoelectrodes on the other side of the chip; determining the electrical voltage on each nanoelectrode by measuring the emitted electron current from each nanoelectrode. In an embodiment, the location of the cells and molecules on the chip is determined by measuring the electrical impedance between adjacent nanoelectrodes. In another embodiment, the cells and molecules are trapped and held at a particular location by applying a predetermined set of electron beam pulses to certain predetermined nanoelectrodes. In another embodiment, the cells and molecules are moved from one location to another by applying a predetermined set of electron beam pulses to certain predetermined nanoelectrodes. In a further embodiment, the nanoelectrodes extend above the surface of the chip such that they are inserted into the cells placed on the chip, enabling the nanoelectrodes to measure properties within the cells. In another embodiment, the nanoelectrodes are modified with specific functional groups to enhance signal contrast resulting from certain chemical properties of the cells.

In another aspect, this invention provides an apparatus for simultaneous nanoscale detection, imaging, manipulation and characterization of living cells and biological molecules comprising of: an array of one or more nanoelectrodes fabricated on a chip, where the nanoelectrodes extend from one side of the chip to the other; a means of placing living cells and biological molecules on the nanoelectrodes on one side of the substrate; a means of applying a focused electron beam in a predetermined manner on one or more nanoelectrodes on the other side of the chip; a means for determining the electrical voltage on each nanoelectrode by measuring the emitted electron current from each nanoelectrode. In one embodiment, the means of applying the focused electron beam comprises of a scanning electron microscope. In another embodiment, the means for determining the electrical voltage on each nanoelectrode comprises a secondary electron energy analyzer.

In another aspect, this invention provides a process for fabrication of an array of one or more nanoelectrodes on a chip. In one embodiment, the chip comprises silicon and the nanoelectrodes comprise carbon nanotubes (CNT). In another embodiment, the chip comprises silicon coated with alumina insulator and the nanoelectrodes comprise a metallic conductor such as gold and platinum.

In another aspect, this invention teaches use of said nanoelectrode array as a nanotweezers to manipulate one or more single molecules simultaneously. In another embodiment, this invention teaches the use of said nanoelectrode array to manipulate very small drops of liquids and reagents. In another embodiment, this invention teaches the use of said nanoelectrode array to manipulate various different single molecules simultaneously to study single molecule reaction kinetics and dynamics. In another embodiment, this invention teaches the use of said nanoelectrode array to manipulate molecules to synthesize new molecules. Furthermore, in another embodiment, this invention teaches the use of said nanoelectrode array to sequence DNA molecules at a high rate. In another embodiment, this invention teaches the use of said nanoelectrode array to be used as a biological sensor to defend against biological terror. In another embodiment, this invention teaches the use of said nanoelectrode array as a neural prosthetic device.

In another aspect, the present invention provides novel nanoelectrodes for use as neural stimulation and recording.

### BRIEF DESCRIPTION OF THE DRAWINGS

FIG. 1 is a high level block diagram of an individually addressable nanoelectrode array in accordance with the present invention.

FIG. 2 shows a cross sectional view of a chip comprising the nanoelectrode array in accordance with the present invention where the chip comprises silicon and nanoelectrodes comprise carbon nanotubes.

FIG. 3 shows a schematic view of various types of nanoelectrodes.

FIG. 4A-4F show a schematic sequence of the process to fabricate a nanoelectrode array chip.

FIG. 5 shows a schematic diagram of a single nanoelectrode comprising of a carbon nanotube.

FIG. 6A-6D show schematic diagrams of different nanoelectrodes comprising one or more carbon nanotubes.

FIG. 7A-7C show a schematic diagrams of a single high surface area nanoelectrode comprising a multitude of carbon nanotubes.

FIG. 8 shows a scanning electron microscope photograph of a single nanoelectrode comprising a multitude of carbon nanotubes.

FIG. 9 shows a scanning electron microscope photograph of a single nanoelectrode comprising a multitude of carbon nanotubes.

FIG. 10 shows a scanning electron microscope photograph of a single nanoelectrode comprising a few carbon nanotubes.

### DETAILED DESCRIPTION OF THE INVENTION

The present invention is based primarily on a two dimensional array of carbon nanotube (CNT) nanoelectrodes fabricated on a micro-machined silicon support substrate using standard microfabrication technologies. The array of nanoelectrodes is embedded in a thin layer of insulator such as silicon dioxide supported by the support silicon substrate, such that the axis of each nanoelectrode is substantially perpendicular to the insulating layer and the silicon substrate. A small length of each nanotube sticks out of the one side of the insulating silicon dioxide layer such that the molecules/cells can be placed on it. Depending on the use, the molecules are placed in between adjacent CNTs or on top of the CNTs. The silicon substrate (0.5-1.0 mm thick) provides the rigid support and strength for the nanoelectrode array. The thickness of the oxide layer, the active area of the nanoelectrode array and the silicon support substrates are designed such that vacuum will be maintained on one side of the nanoelectrode array if necessary while exposing the other side to atmospheric pressure.

The present invention uses a focused electron beam to apply voltage to each individual nanoelectrode in a predetermined sequence. An electron beam is chosen because focused e-beams form the smallest probe size. Currently, it is possible to achieve e-beam spot size as small as 1 nm in e-beam lithography systems and various scanning electron microscopes (SEM), while the laser focused spots are limited to over 100 nm. This focused electron beam is used to charge various nanoelectrodes to a desired voltage. The same electron beam will also be used to determine (read) the voltage on the electrodes by measuring the energy of the secondary electrons emitted from the nanoelectrode (by measuring the energy of emitted electrons that is reduced by the electrode potential). If desired, both these actions can be accomplished at the same time, i.e. while the primary e-beam is charging a nanoelectrode, the emitted secondary electrons can be energy analyzed to obtain a real time feedback on the actual voltage of the nanoelectrode.

The use of electron beams to apply voltage to an electrode and to measure electrode voltage is well known in the art of electron beam testing of silicon integrated circuits and have been described in detail in the literature. In particular, a recent book (Electron Beam Testing technology, edited by John T. L. Thong) deals entirely with the science and technology of use of electron beams for testing silicon chips with electron beams.

Briefly, it is easy to understand the charging of the CNT nanoelectrode when free electrons from the e-beam (primary electrons) hit the nanoelectrode. The amount of voltage is determined by the capacitance of the electrode, the leakage of current through the insulating layer, and the current and time for which the e-beam hits the electrode. Ignoring the charge leakage effect, the voltage rise of the electrode is given by the relation, V=It/C, where I is the beam current, t is the time the beam is allowed to hit the electrode and C is the capacitance of the electrode. Assuming the capacitance to be 1 picofarad, a typical 1 nA beam will charge a CNT electrode at a rate of approximately 1 millivolts per microsecond. This is a very controllable rate for achieving voltages in the 100-500 mV range for biological studies. Furthermore, in practice, there is always emission of secondary electrons from the surface of the electrode that reduces the charging rate. Additionally, the primary e-beam energy can be changed such that the number of secondary electrons can be less or more than the primary electrons. If the secondary electrons are less than primary electrons, the electrode charges to a negative potential. If the secondary electrons are more than primary electrons, the electrode charges to a positive potential. Furthermore, by changing the time percentage of the e-beam bombardment on to a CNT, the voltage can be varied in a linear or sinusoidal waveform. The discharging of a CNT is accomplished by changing the primary e-beam conditions from positive charging to negative charging or vice versa, or by using a second low energy flood gun or simply due to leakage through the substrate.

Nanoelectrode voltage measurement with electron beams is harder to understand, but is easily accomplished with current electronic instrumentation. It is based on the principle that the energy of the secondary electrons emitted from a charged electrode is reduced by the electrode potential. Thus, when the secondary electrons emitted from the nanoelectrode are collected and their energy is analyzed, the voltage on the electrode can be determined. Typically, a simple mesh detector is used as the secondary electron collector and the collected electrons are accelerated towards a PMT (photo multiplier tube), thereby resulting in a very large gain and high signal to noise ratio. This signal is analyzed with a typical high speed electronics setup to determine the minimum cut-off of the collected electrons, which represents the electrode voltage. Since all the changes in detector potential are done at a rapid rate in synchronization with the primary e-beam position and energy, the detected signal can measure the CNT nanoelectrode voltage in real time.

Furthermore, the combination of changing the voltage applied to a nanoelectrode (or applied between various nanoelectrodes) will allow application of a voltage to different parts of a cell placed on the array, while the real time potential measurement on a third CNT will correlate the current measurement at this node. This approach allows typical voltammetric and amperometric measurements with the present nanoelectrode array.

The use of a two sided individually addressable nanoelectrode array in the present invention allows the sample to be kept in air or biological medium while the e-beam hits the other side of the present nanoelectrode array. This allows the cells to be kept alive in a biological medium while they are being examined or manipulated. The key advantage of the present invention is that the e-beam never hits the biological sample.

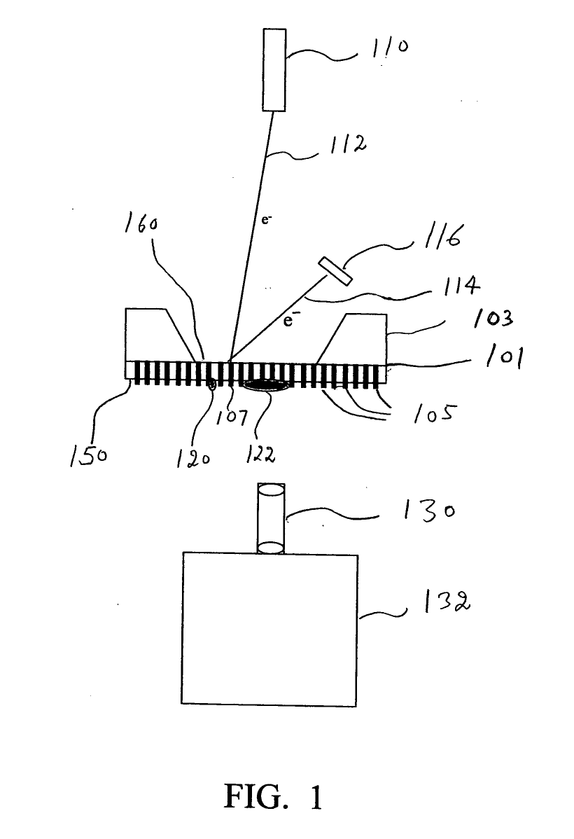

Referring now to the drawings, FIG. 1 shows a schematic block diagram of the present invention, where living cells 122 and biological molecules 120 are placed on one face 150 of a nanoelectrode array chip 101 fabricated on a support silicon substrate 103. The side 150 is in air while the side 160 is typically in vacuum. This is usually accomplished with the use of a typical vacuum adapter plate mounted to the vacuum chamber containing the primary electron beam column and associated secondary electron (SE) detector. In another embodiment, an array of miniature field emission electron sources can be used as the primary beam placed very close to the nanoelectrode array. In this embodiment, there is no need to evacuate the electron beam side of the nanoelelctrode array. Going back to FIG. 1, a focused primary electron beam 112 is emitted from an electron beam column under computer control software to hit a particular nanoelectrode 107 on the face 160 for a predetermined and controlled time. As described earlier, this increases the voltage on the nanoelectrode 107 without affecting substantially the other nanoelectrodes. The primary electron beam also causes secondary electrons 114 to be emitted from the said nanoelectrode 107, that are collected and analyzed by a secondary electron analyzer 116 to determine the voltage of nanoelectrode 107. This induced voltage is used to manipulate a molecule or a cell on top of or in close proximity to the said nanoelectrode 107. In another case, similar approach is used to determine the voltage induced by a molecule or cell on a particular nanoelectrode. While the electron beam 110 is being used to image and manipulate the cells and molecules on the said array, other analytical instruments 130 and 132 may also be used to in-situ observe the cells and molecule. These instruments include but are not limited to optical microscopy, fluorescence spectroscopy and laser induced spectroscopy.

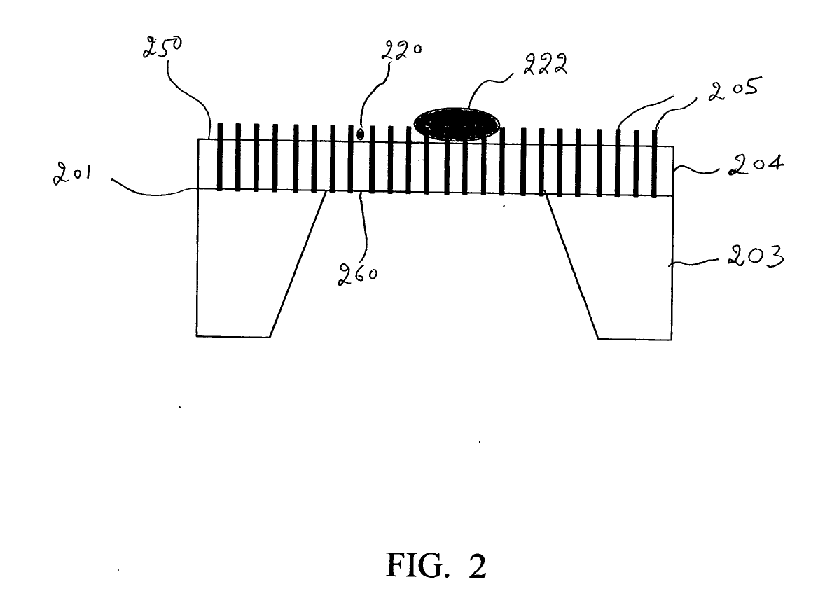

FIG. 2 shows a schematic diagram of a preferred embodiment for the nanoelectrode array chip 201. The support substrate 203 consists of a standard silicon wafer of 0.5 mm thickness with a micromachined silicon oxide membrane 204 suspended in the center. Embedded in the said silicon oxide membrane are a plurality of vertically aligned carbon nanotubes which extend to both faces 250 and 260 of the said membrane. The CNTs are very small (1-100 nm diameter) and the distance between adjacent CNTs is only 10-10,000 nm, the active area for a 100×100 CNT array is less than 100 um×100 um. In the preferred embodiment, the typical chips have a size of approximately 1 cm×1 cm silicon chip with an active area of 1 mm×1 mm and contain many (typically 100) 10×10 arrays. The thickness of the active area is on the order of a few micrometers thick. In other embodiments, the silicon substrate is replaced by other materials such as alumina, glass, quartz and sapphire. The carbon nanotubes may also be replaced by metallic nanowires and nanorods made from gold, carbon, platinum, nickel, palladium and iridium.

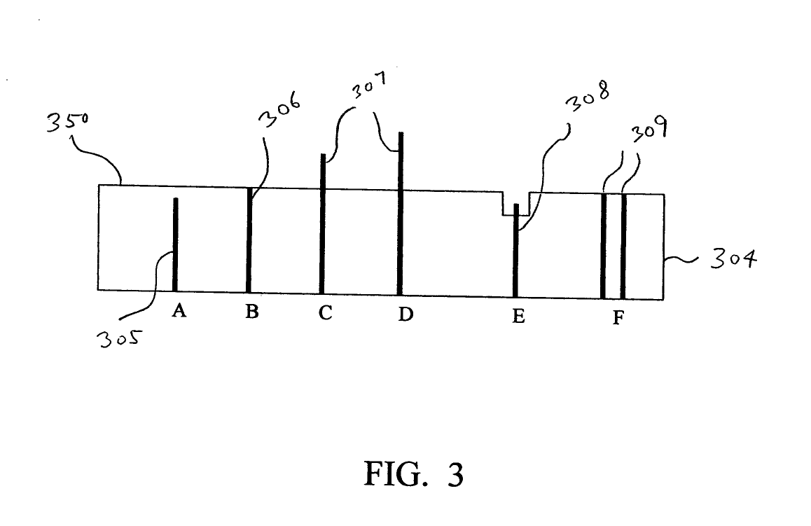

FIG. 3 shows schematically several shapes of nanoelectrodes that are used for fabricating the nanoelectrode arrays. A nanoelectrode 305 is embedded in the insulating layer 304 and can be used for both manipulation and voltage sensing. This type of nanoelectrode is useful when the biological medium placed on the array has high electrical conductivity. Nanoelectrode 306 is another embodiment that has its tip flush with the array surface such that it provide direct electrical contact with the cells and molecule but does not interfere with their physical movement on the array surface. Nanoelectrodes 307 depict another embodiment of the penetrating nanoelectrode that is used to penetrate the surface of cells and other tissues to image the inside of said cells and tissues. Nanoelectrode 308 is another embodiment of the embedded nanoelectrode 305. Nanoelectrodes 309 are used for sensing and sizing purposes. The electrical impedance (resistance at high frequency @1-10 kHz) is measured for two adjacent nanoelectrodes 309 placed 10-100 nanometers apart using the e-beam probing described earlier (applying voltage to one CNT and measuring rate of voltage change on the other CNT). This impedance changes significantly when a cell/molecule is moved in-between or on top of these nanoelectrodes, and thus can be sensed.

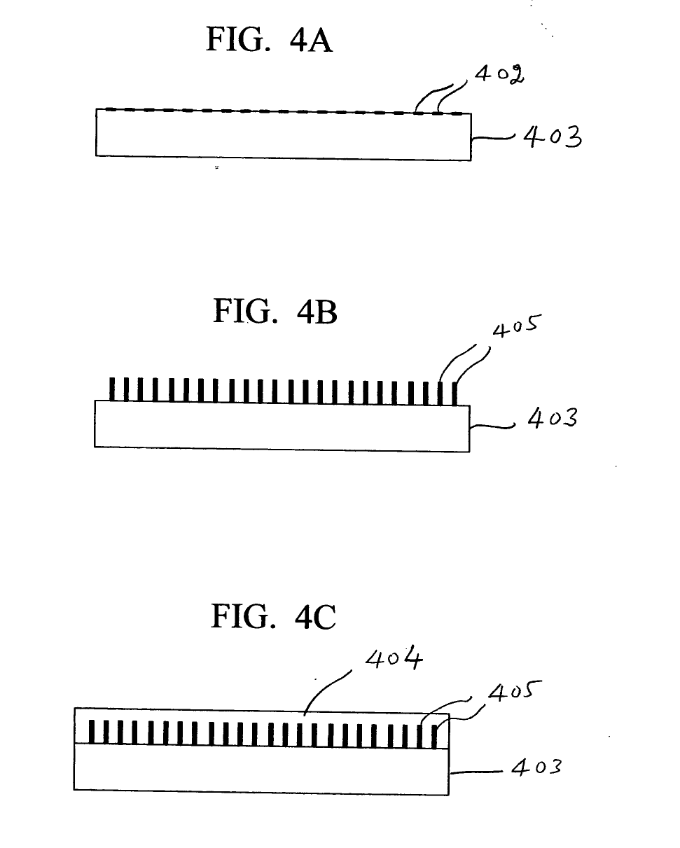

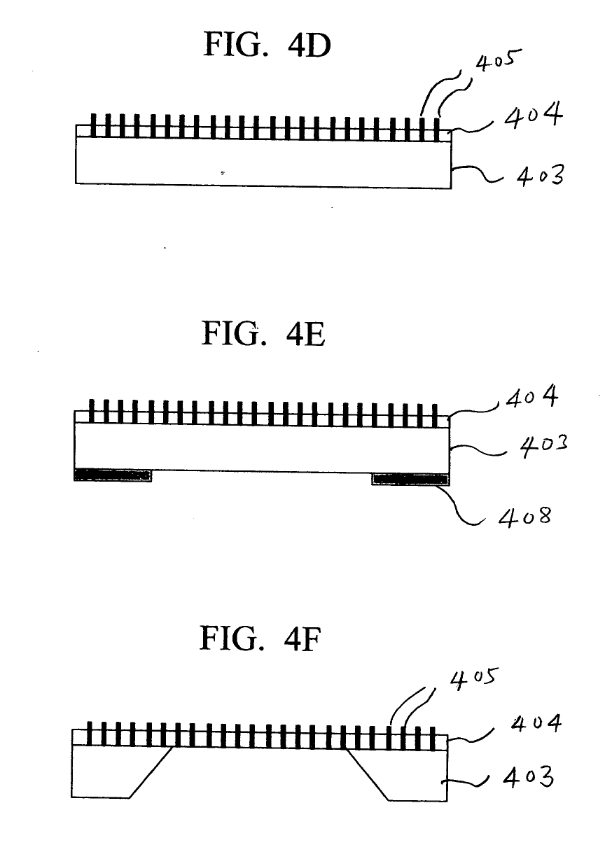

FIG. 4 schematically shows a process sequence to fabricate nanoelectrode array chip 101 shown in FIG. 1. The various steps shown in FIG. 4A-4G are typically used in microfabrication of integrated circuits and microelectromechanical systems (MEMS), and are known very well in the fabrication of such chips. Several recent books on the nanotechnology field describe the technologies used the present invention in detail. In particular, two recent books published in 2004 describe the techniques used in the present fabrication process sequence; (1) ‘Nanotechnology, An Introduction to Nanostructuring Techniques’ by Michael Kohler and Wolfgang Fritzsche (ISBN: 3-527-30750-8), and (2) ‘Springer Handbook of Nanotechnology’ edited by Bharat Bhushan (ISBN: 3-540-01218-4).

Referring now to FIG. 4A, the fabrication process consists of a key first step involving fabrication of nanometer size dots patterned on photo-resist coated silicon wafer 403 using an electron beam and focused ion beam lithography system. These wafers will be cut into 1cm×1 cm pieces and the dots will be transferred into a thin evaporated nickel layer on the silicon wafer by standard lift-off process resulting in the nickel dots 402 in a predetermined configuration on the wafer 403. These thin nickel dots 402 act as the nucleation sites during CNT growth using a typical plasma enhanced chemical vapor deposition process used for aligned CNT growth. During this CNT growth plasma enhanced chemical vapor deposition process, the growing CNTs are bombarded with energetic ions from the plasma, preferentially eroding non-aligned CNTs, thereby resulting in perfectly aligned CNTs 405 as shown in FIG. 4B. For example, an array of aligned CNTs by this process is shown on page 320 in another 2004 book ‘Nano and Micro Engineered Membrane Technology’ by C.J.M. Rijn (ISBN: 0-444-51489-9).

FIG. 4C shows the step of coating the CNTs 405 with a layer 404 of insulating lead doped silicon dioxide (lead doping is to reduce the radiation damage to living samples due to x-rays), such that the insulator fills the spaces in between the CNTs. The next step is shown in FIG. 4D and involves post-processing to etch back the insulator 404 and obtain the proper shape of the CNT nanoelectrodes as determined in FIG. 3. Depending on the shape desired, this post processing can take several steps involving wet and dry etching.

After the formation of CNT nanoelectrodes, FIG. 4E and 4F show the steps of masking the other side of the wafer with a photolithographically patterned metal mask 408 followed by etching the back of the wafer selectively all the way to the silicon dioxide. The above structure will be argon ion milled to clean both sides of the chip to obtain the chip shown in FIG. 4F.

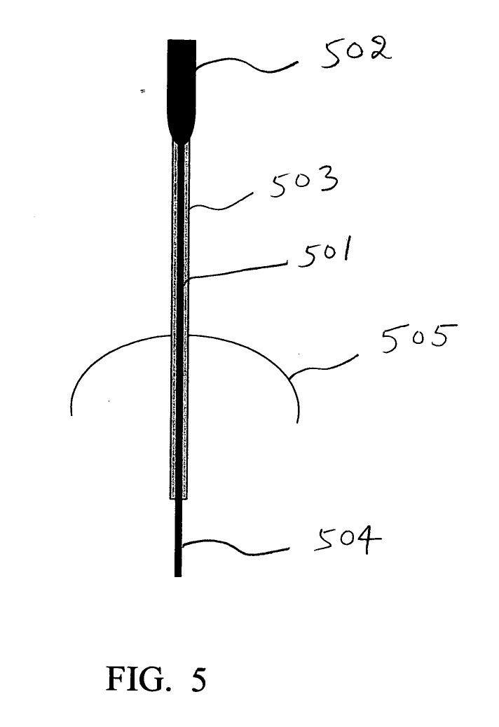

FIG. 5 shows another nanoelectrode embodiment where the carbon nanotube 501 is coated partially with an insulating layer 503, such that only the tip 504 is electrically active. Furthermore, in another embodiment, the CNT 501 can be attached to a metallic needle (e.g. a sharpened tungsten or silicon needle) 502 with conductive epoxy of other standard techniques. This reduces the stray noise when the nanoelectrode is inserted in a cell 505.

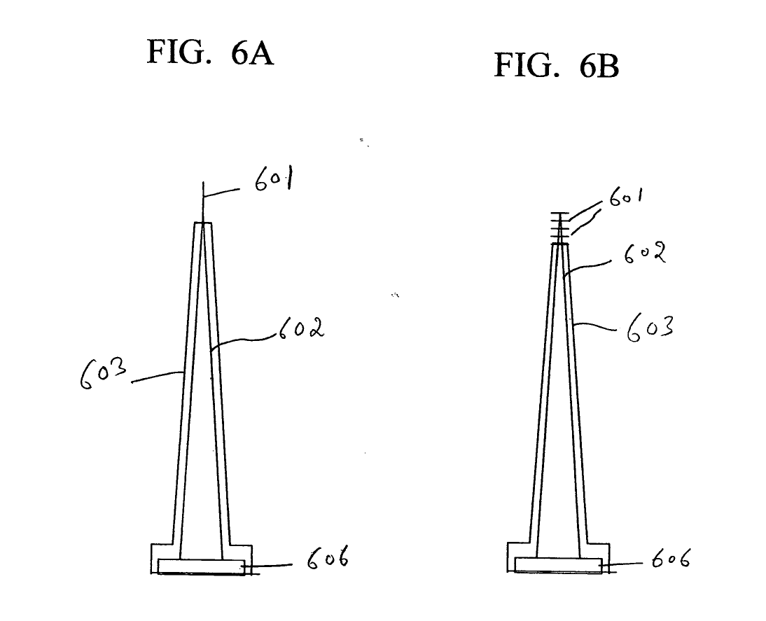

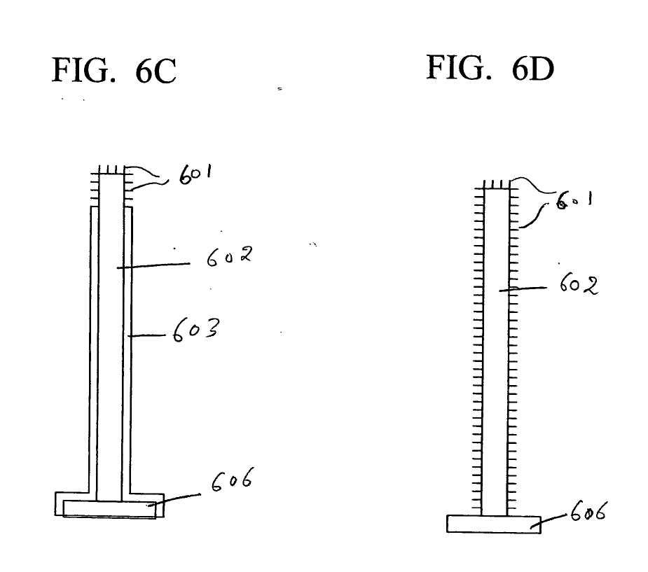

FIG. 6A-D show several other embodiments of nanoelectrodes that may be used individually as in configuration shown in FIG. 5 or in arrays as in configuration shown in FIG. 2.

Referring now to FIG. 6A, a carbon nanotube (or a nanowire or a nanorod) 601 is attached to (oe grown on) a sharpened metal needle 602, followed by coating of the metal needle 602 and parts of CNT 601 with an insulating layer 603. In another embodiment, the metal needle may be microfabricated on a metal interconnect pad (or via) 606 to transport the signal obtained by the CNT 601. FIG. 6B shows another embodiment where a multitude of CNTs 601 is attached to the nanoelectrode. FIG. 6C and 6D show other embodiments where large number of aligned CNTs 601 are attached to small diameter metal wires and needles 602 to fabricate very high surface area elelctrodes.

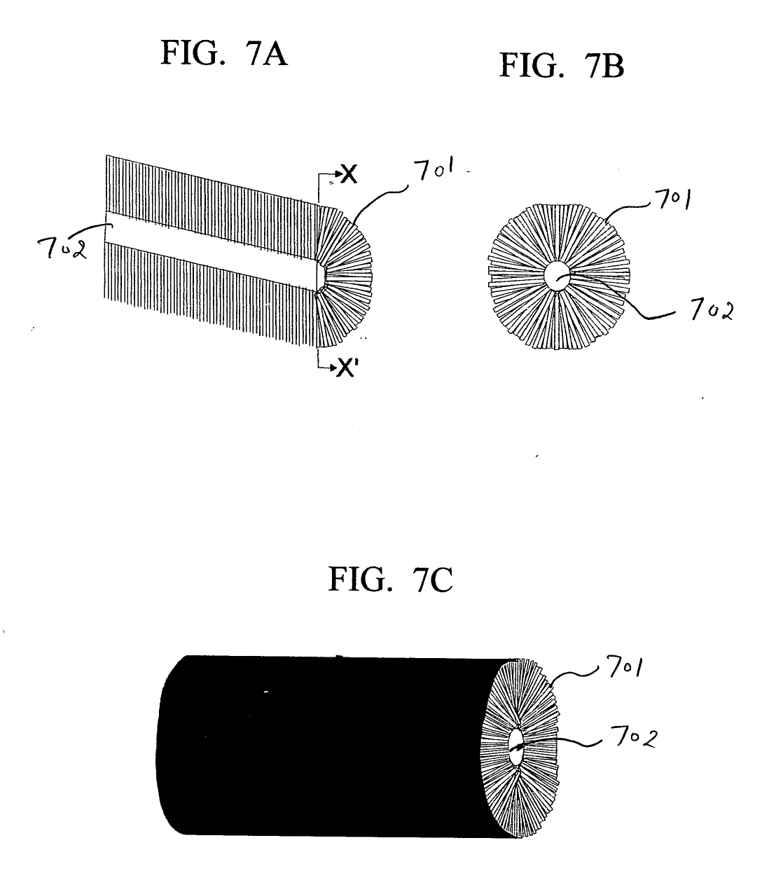

FIG. 7A-7C show different views of a high surface area electrode formed by coating aligned CNTs 701 on the shank of a rhetal wire 702. This increases the surface area of the electrode significantly without increasing the physical area substantially. This results in improved signal to noise performance without loss of electrode array resolution. In another embodiment, a biocompatible coating such as platinum, gold or iridium is coated on CNT modified metal wire without any substantial loss in surface area enhancement.

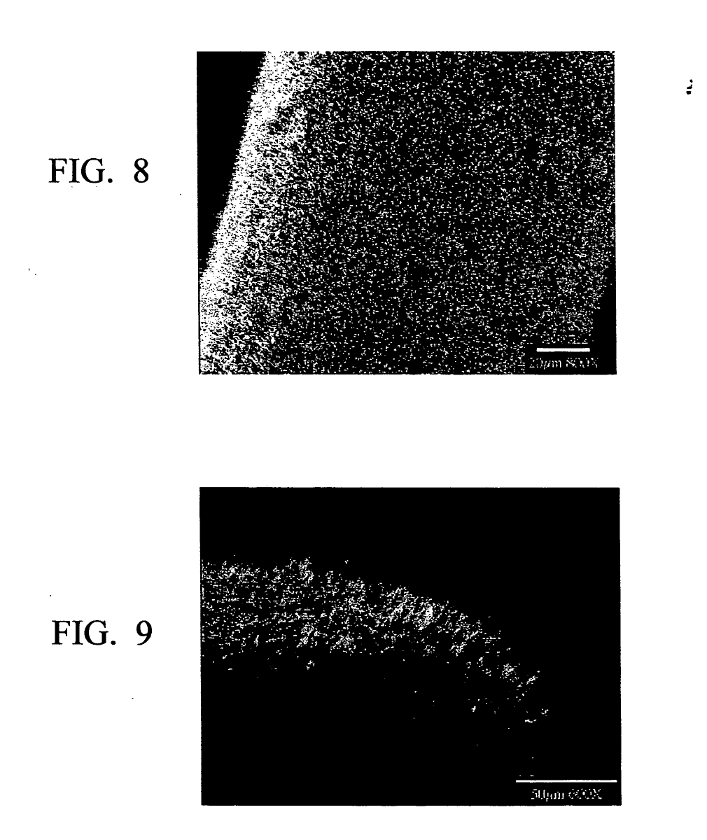

FIG. 8 shows a scanning electron microscope image of a nanoelectrode fabricated in accordance with FIG. 7. This nanoelectrode was fabricated using plasma enhanced chemical vapor deposition of multi-walled CNTs on a 200 micron diameter nickel wire.

FIG. 9 shows a scanning electron microscope image of a nanoelectrode fabricated in accordance with FIG. 6B. This nanoelectrode was fabricated using plasma enhanced chemical vapor deposition of multi-walled CNTs on a sharpened 200 micron diameter nickel wire.

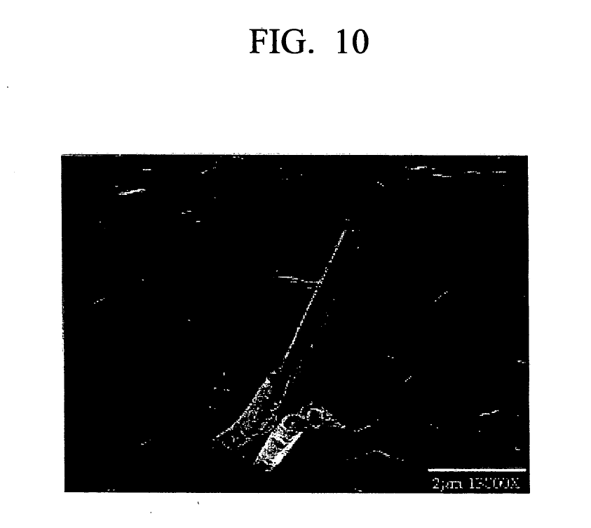

FIG. 10 shows a scanning electron microscope image of a nanoelectrode fabricated in accordance with FIG. 6A. This nanoelectrode was fabricated using plasma enhanced chemical vapor deposition of multi-walled CNTs on a finely sharpened 200 micron diameter nickel wire.

In all of the above embodiments of the present invention, CNTs used can be of different sizes, can be single walled or multi-walled, can be either hollow or solid (filled or capped) based on the application, and may include bundles of CNTs instead of a single CNT. Furthermore, these may include nanotubes and nanorods made not only from carbon but from other materials such various metals and compounds as well.

While the invention has been described with respect to specific embodiments for complete and clear disclosure, the claims are not to be thus limited but are to be construed as embodying all modifications and alternative constructions that may occur to one skilled in the art which fairly fall within the basic teaching here set forth.

1. A method for nanoscale detection, imaging, manipulation and characterization of living cells and biological molecules comprising the steps of:
providing an array of one or more nanoelectrodes fabricated on a chip, where the nanoelectrodes extend from one side of the chip to the other;
placing living cells and biological molecules on the nanoelectrodes on one side of the chip;
applying a focused electron beam in a predetermined manner on one or more nanoelectrodes on the other side of the chip;
determining the electrical voltage on each nanoelectrode by measuring the emitted electron current from each nanoelectrode.
